(19) United States
(12) Patent Application Publication
(10) Pub. No.: US 2026/0367940 A1
(43) Pub. Date: Nov. 19, 2026

(54) REMINDER USER INTERFACE

(71) Applicant: Apple Inc., Cupertino, CA (US)

(72) Inventors: Bryn BOWMAN, Lafayette, CA (US); Jae Woo CHANG, Los Altos Hills, CA (US); Dominic DAVIES, Los Angeles, CA (US); Jarrett A. FORD, Alameda, CA (US); Tara MANN, West Hollywood, CA (US); Gabriella ROSSI, Berkeley, CA (US)

(21) Appl. No.: 19/390,350

(22) Filed: Nov. 14, 2025

Related U.S. Application Data
(60) Provisional application No. 63/807,177, filed on May 16, 2025.

(51) Int. Cl. G06F 9/451; G06F 3/04842

(52) U.S. Cl. CPC G06F 9/451; G06F 3/04842

(57) ABSTRACT

The present disclosure generally relates to reminder user interfaces. For example, from a communication user interface that includes representations of communications (e.g., phone calls, video calls, voicemails, and/or messages), selecting a representation of a particular communication provides options for creating a reminder based on the selected communication, and a representation of the created reminder is displayed in the communication user interface in a different section from the representations of the communications.

### CROSS-REFERENCE TO RELATED APPLICATIONS

This application claims priority to U.S. Provisional Patent Application No. 63/807,177, entitled “REMINDER USER INTERFACE,” filed on May 16, 2025, the content of which is incorporated by reference for all purposes.

### FIELD

The present disclosure relates generally to computer user interfaces, and more specifically to techniques for providing reminders.

### BACKGROUND

Electronic devices such as smart phones, tablets, and wearable devices, are used to provide reminders to users of the electronic devices. For example, electronic devices provide user interfaces for setting up reminders that are to be delivered by the electronic devices at particular times and/or particular locations.

### BRIEF SUMMARY

Some techniques for providing reminders using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing reminders. Such methods and interfaces optionally complement or replace other methods for providing reminders. Such methods and interfaces reduce the cognitive burden on a user and produce a more efficient human-machine interface. For battery-operated computing devices, such methods and interfaces conserve power and increase the time between battery charges.

In accordance with some embodiments, a method performed at a computer system that is in communication with one or more display generation components and one or more input devices is described. The method includes: while displaying, via the one or more display generation components, a communication user interface that includes one or more representations of one or more respective communications: detecting, via the one or more input devices, a first set of one or more inputs directed to a representation of a first communication; in response to detecting the first set of one or more inputs directed to the representation of the first communication, displaying, via the one or more display generation components, a reminder user interface option; and, after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein: the representation of the first reminder associated with the first communication is displayed in a first region of the communication user interface; and the one or more representations of the one or more respective communications are displayed in a second region of the communication user interface that is different from the first region of the communication user interface.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: while displaying, via the one or more display generation components, a communication user interface that includes one or more representations of one or more respective communications: detecting, via the one or more input devices, a first set of one or more inputs directed to a representation of a first communication; in response to detecting the first set of one or more inputs directed to the representation of the first communication, displaying, via the one or more display generation components, a reminder user interface option; and, after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein: the representation of the first reminder associated with the first communication is displayed in a first region of the communication user interface; and the one or more representations of the one or more respective communications are displayed in a second region of the communication user interface that is different from the first region of the communication user interface.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: while displaying, via the one or more display generation components, a communication user interface that includes one or more representations of one or more respective communications: detecting, via the one or more input devices, a first set of one or more inputs directed to a representation of a first communication; in response to detecting the first set of one or more inputs directed to the representation of the first communication, displaying, via the one or more display generation components, a reminder user interface option; and, after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein: the representation of the first reminder associated with the first communication is displayed in a first region of the communication user interface; and the one or more representations of the one or more respective communications are displayed in a second region of the communication user interface that is different from the first region of the communication user interface.

In accordance with some embodiments, a computer system is described. The computer system is configured to communicate with one or more display generation components and one or more input devices, and the computer system comprises: means for, while displaying, via the one or more display generation components, a communication user interface that includes one or more representations of one or more respective communications: detecting, via the one or more input devices, a first set of one or more inputs directed to a representation of a first communication; in response to detecting the first set of one or more inputs directed to the representation of the first communication, displaying, via the one or more display generation components, a reminder user interface option; and, after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein: the representation of the first reminder associated with the first communication is displayed in a first region of the communication user interface; and the one or more representations of the one or more respective communications are displayed in a second region of the communication user interface that is different from the first region of the communication user interface.

In accordance with some embodiments, a computer system is described. The computer system is configured to communicate with one or more display generation components and one or more input devices, and the computer system comprises: one or more processors; and memory storing one or more programs configured to be executed by the one or more processors, the one or more programs including instructions for: while displaying, via the one or more display generation components, a communication user interface that includes one or more representations of one or more respective communications: detecting, via the one or more input devices, a first set of one or more inputs directed to a representation of a first communication; in response to detecting the first set of one or more inputs directed to the representation of the first communication, displaying, via the one or more display generation components, a reminder user interface option; and, after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein: the representation of the first reminder associated with the first communication is displayed in a first region of the communication user interface; and the one or more representations of the one or more respective communications are displayed in a second region of the communication user interface that is different from the first region of the communication user interface.

In accordance with some embodiments, a computer program product is described. The computer program product is configured to be executed by one or more processors of a computer system that is in communication with one or more display generation components and one or more input devices, the one or more programs including instructions for: while displaying, via the one or more display generation components, a communication user interface that includes one or more representations of one or more respective communications: detecting, via the one or more input devices, a first set of one or more inputs directed to a representation of a first communication; in response to detecting the first set of one or more inputs directed to the representation of the first communication, displaying, via the one or more display generation components, a reminder user interface option; and, after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein: the representation of the first reminder associated with the first communication is displayed in a first region of the communication user interface; and the one or more representations of the one or more respective communications are displayed in a second region of the communication user interface that is different from the first region of the communication user interface.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for providing reminders, thereby increasing the effectiveness, efficiency, and user satisfaction with such devices. Such methods and interfaces may complement or replace other methods for providing reminders.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6M illustrate example techniques and systems for providing reminders based on electronic communications, in accordance with some embodiments.

FIG. 7 illustrates a flow diagram of methods for providing reminders based on electronic communications, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for providing reminders. For example, an efficient user interface for providing reminders is provided within a communication user interface, allowing users to create reminders based on communications represented in the communication user interface and to view the created reminders in the communication user interface in a separate section from the representations of the communications. Such techniques can reduce the cognitive burden on a user who use electronic devices to provide reminders, thereby enhancing productivity. Further, such techniques can reduce processor and battery power otherwise wasted on redundant user inputs.

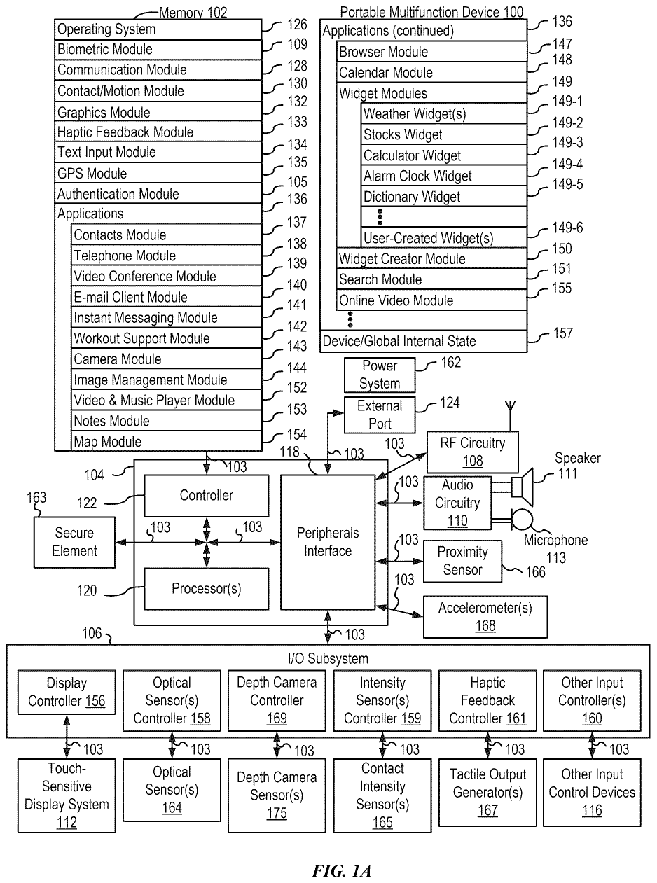

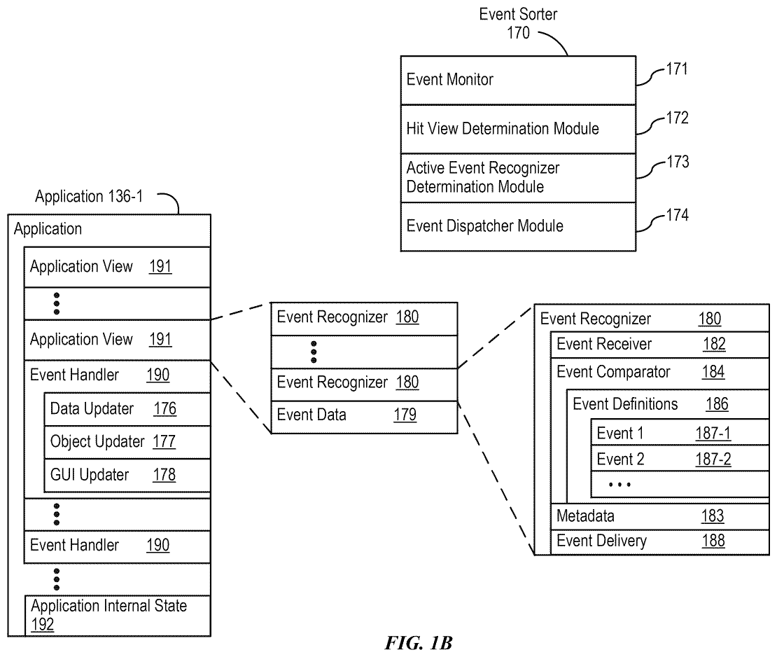

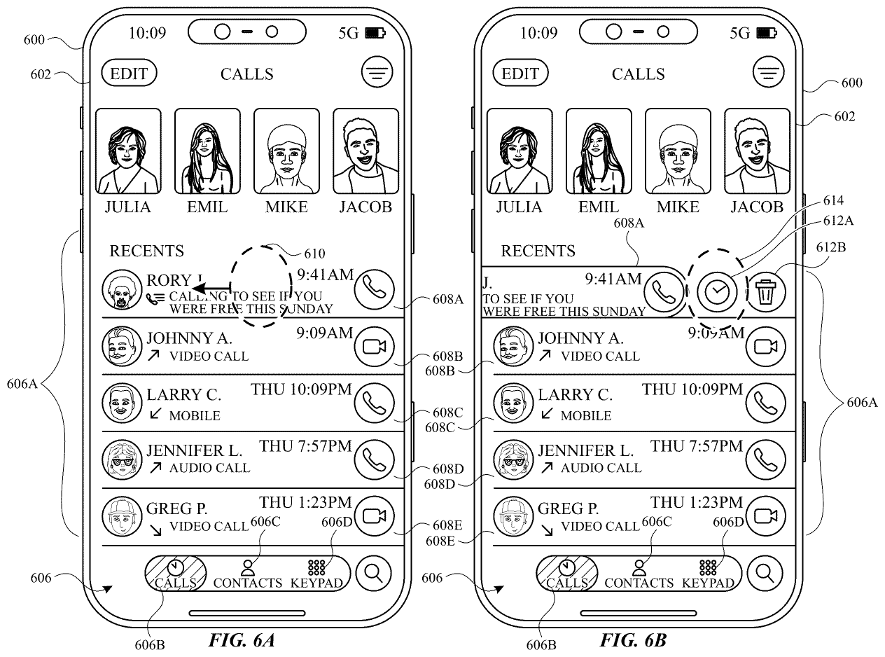

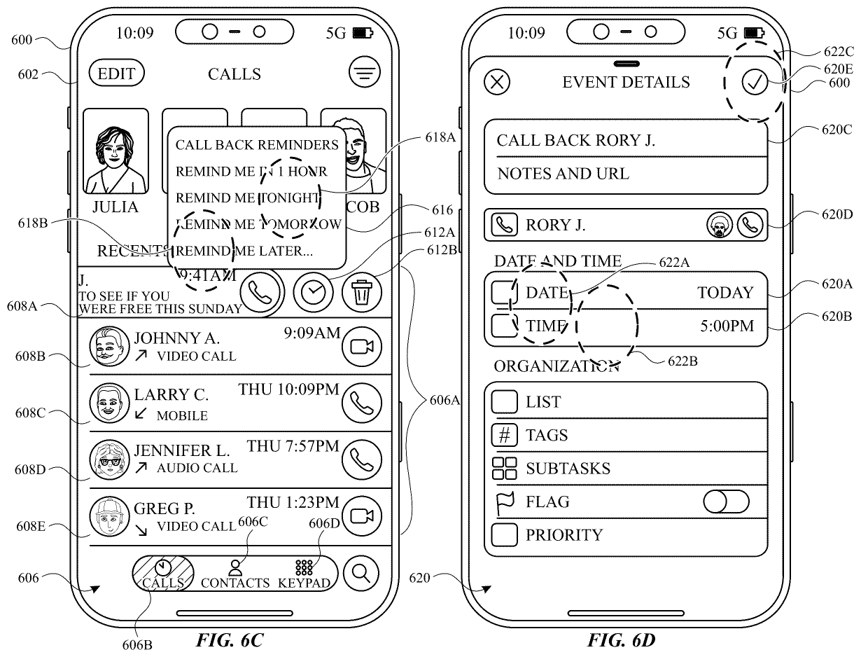

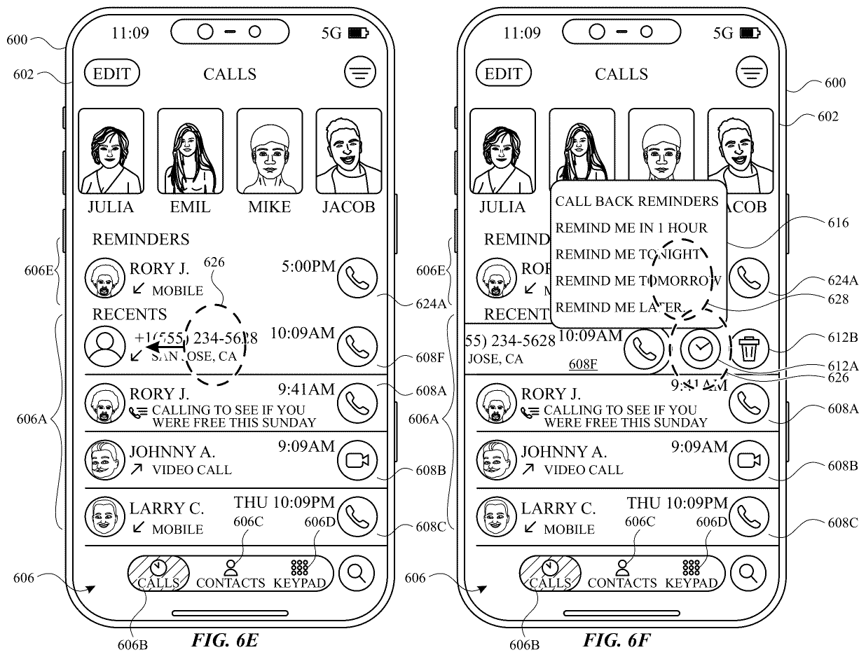

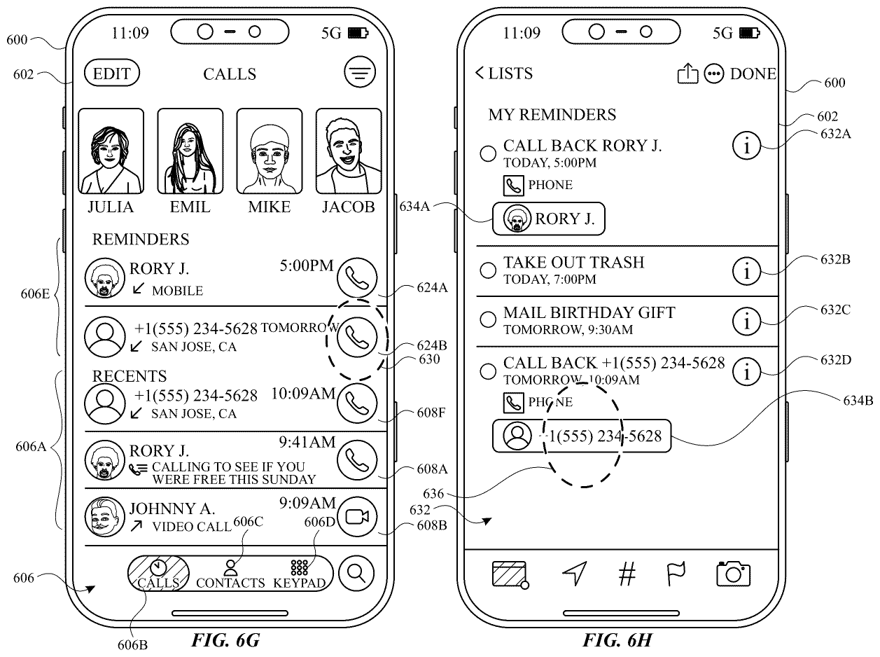

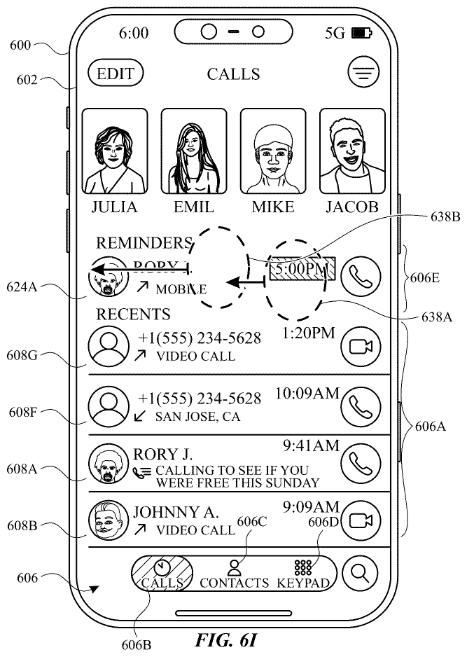

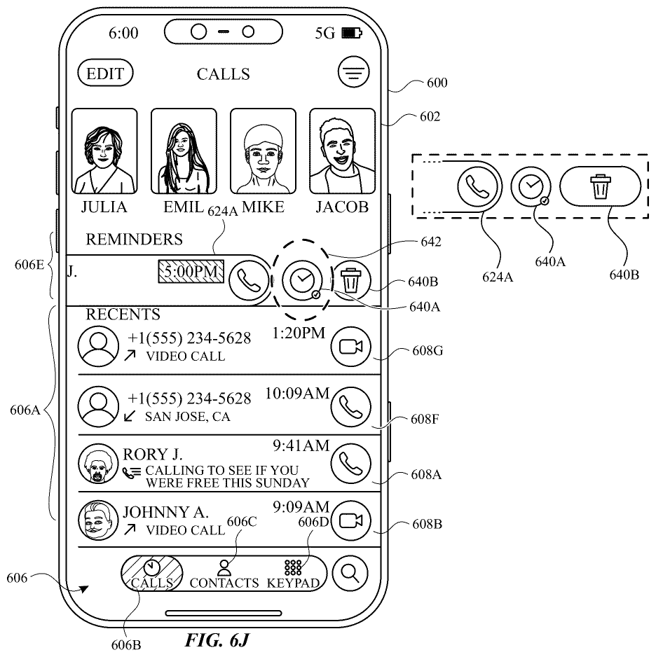

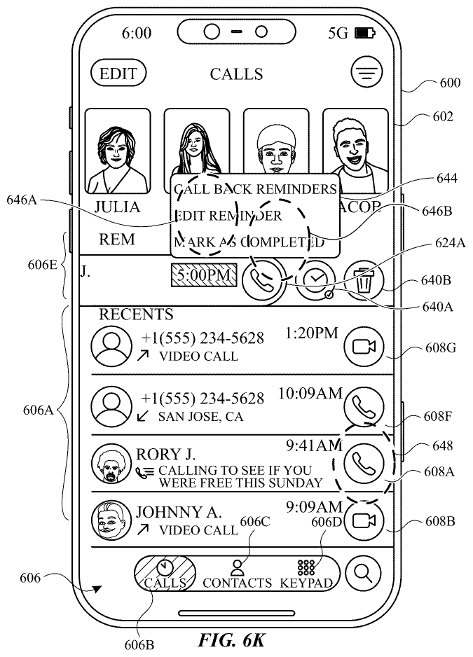

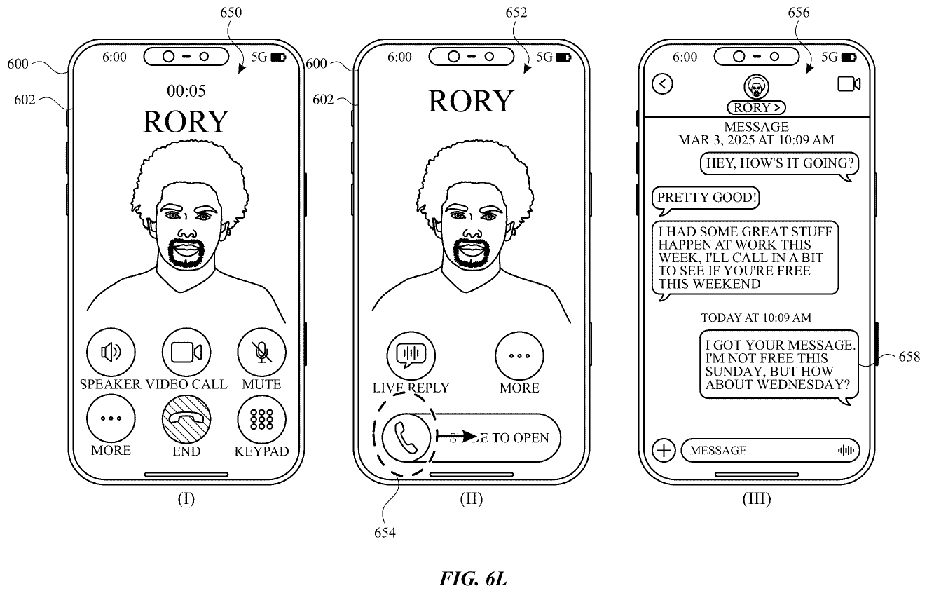

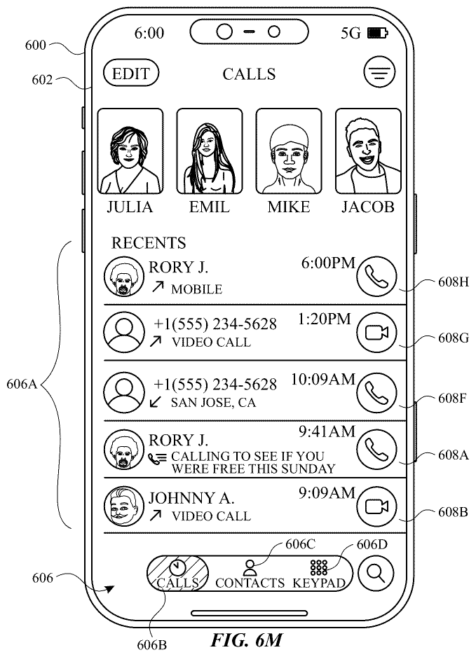

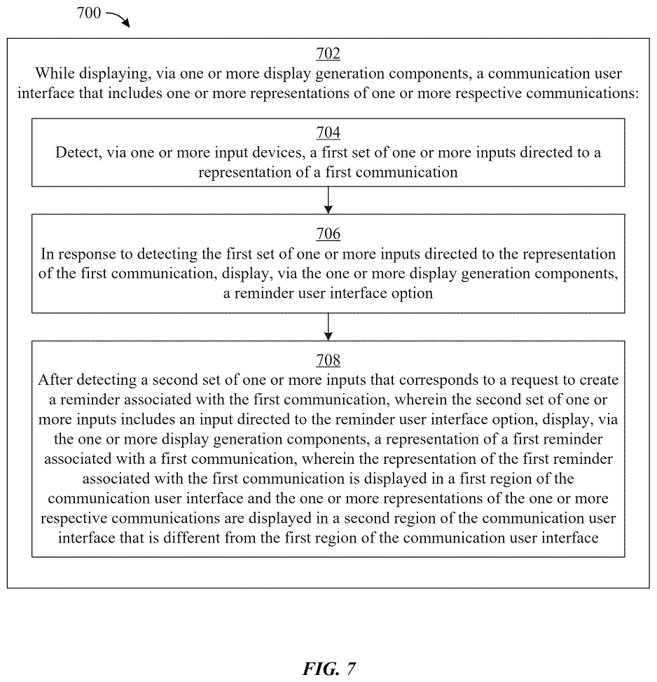

Below, FIGS. 1A-1B, 2, 3A-3G, 4A-4B, and 5A-5B provide a description of exemplary devices for performing the techniques for providing reminders based on electronic communications. FIGS. 6A-6M illustrate exemplary user interfaces for providing reminders based on electronic communications. FIG. 7 is a flow diagram illustrating methods of providing reminders based on electronic communications. The user interfaces in FIGS. 6A-6M are used to illustrate the processes described below, including the processes in FIG. 7.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

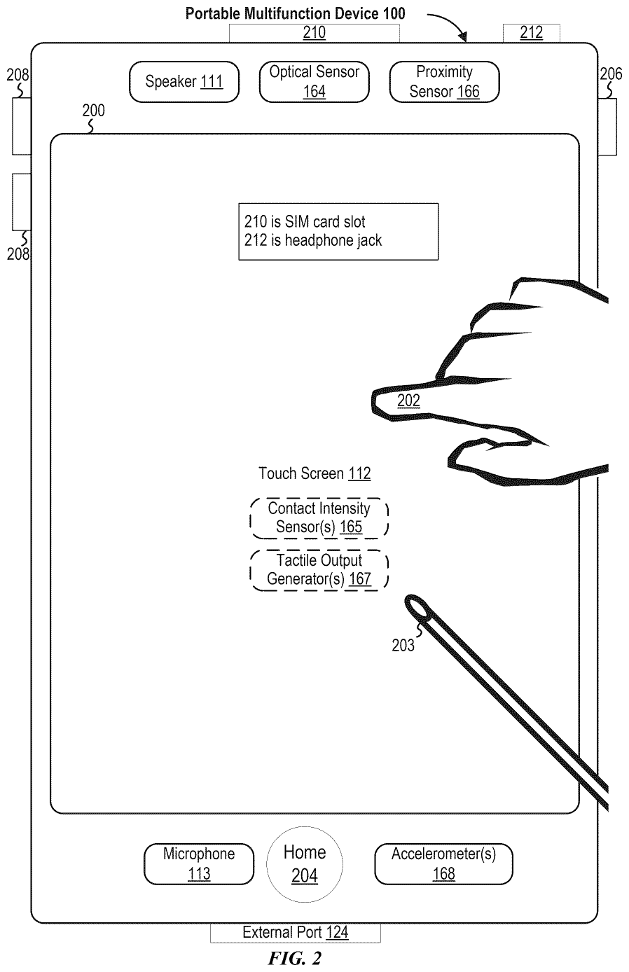

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

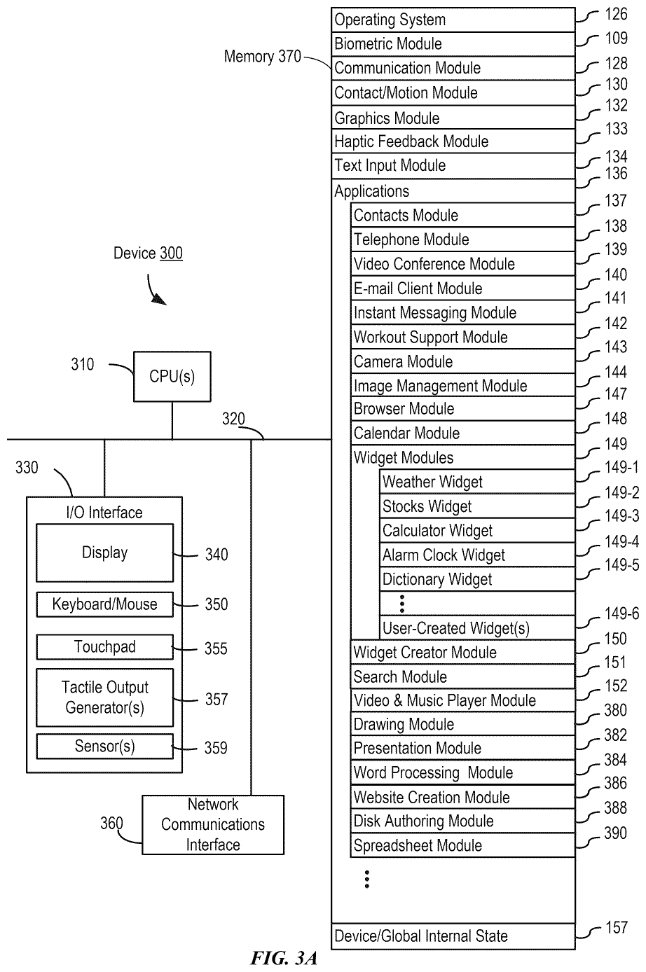

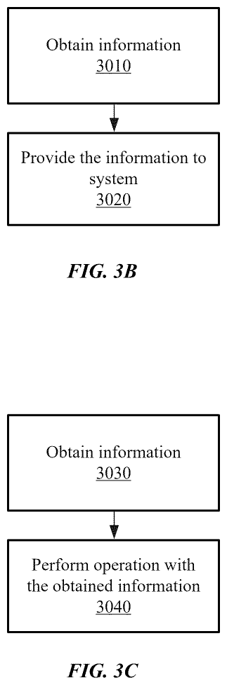

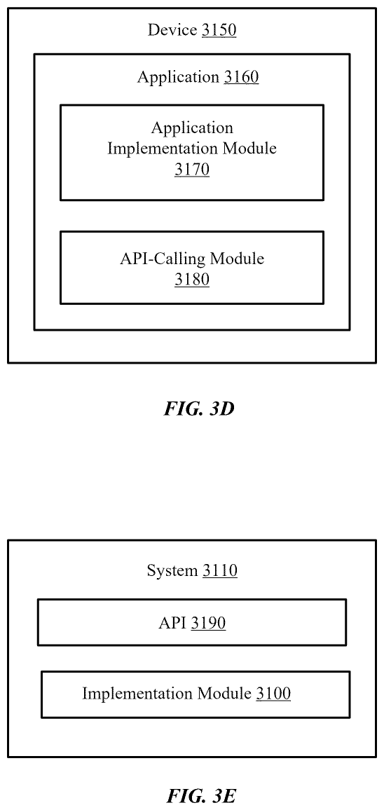

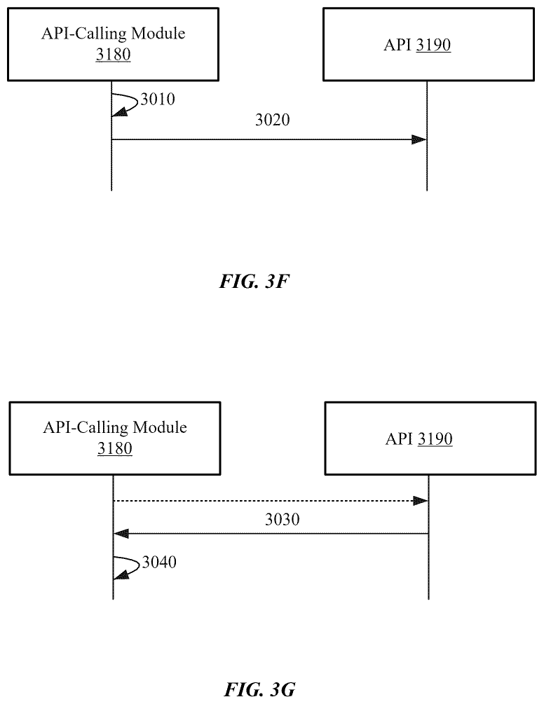

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

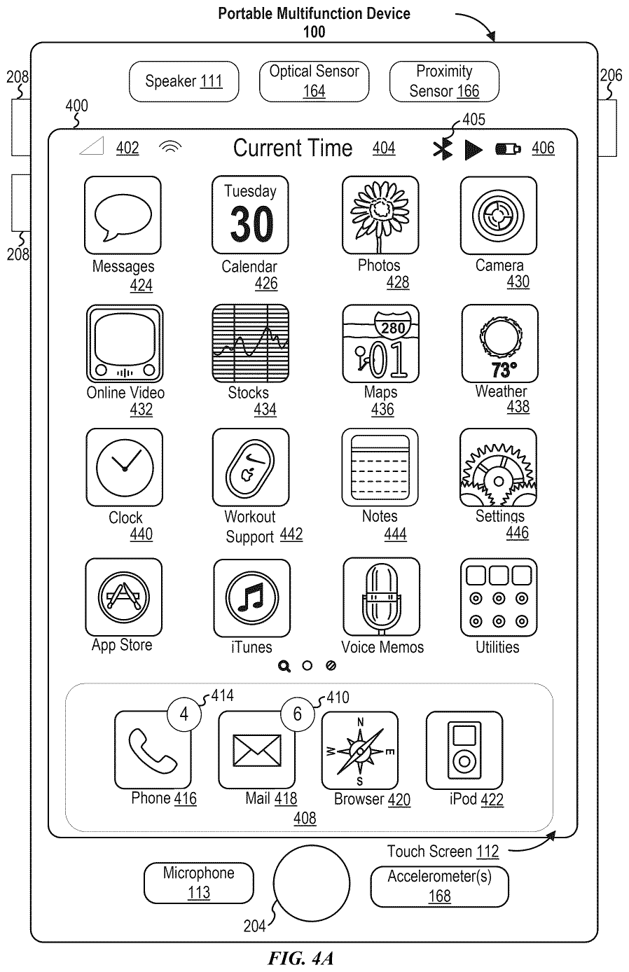

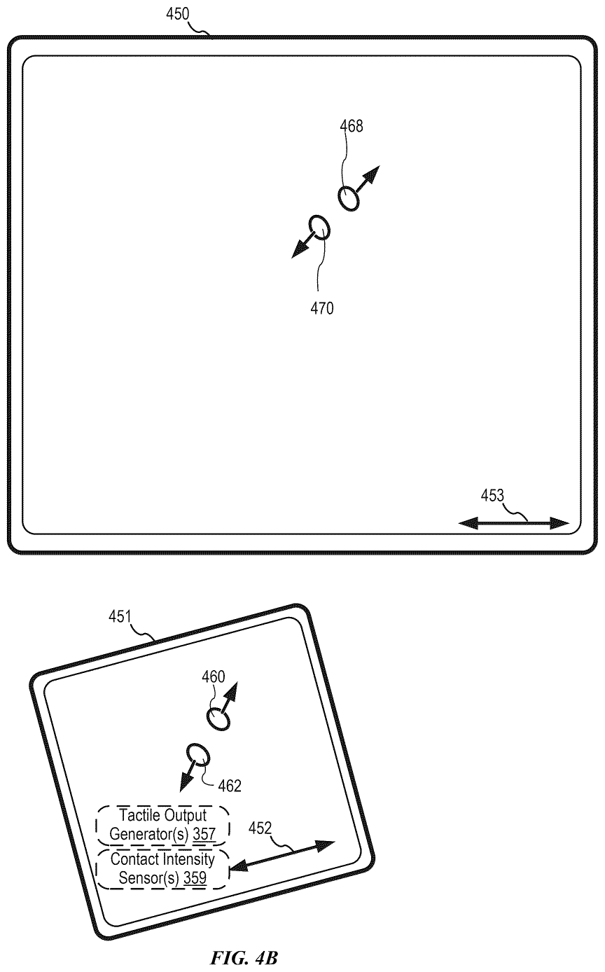

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

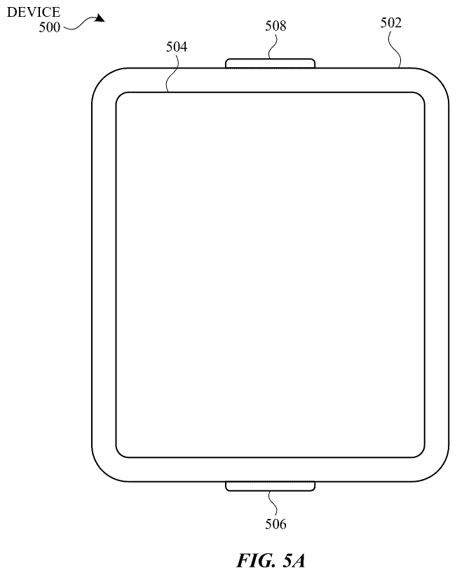

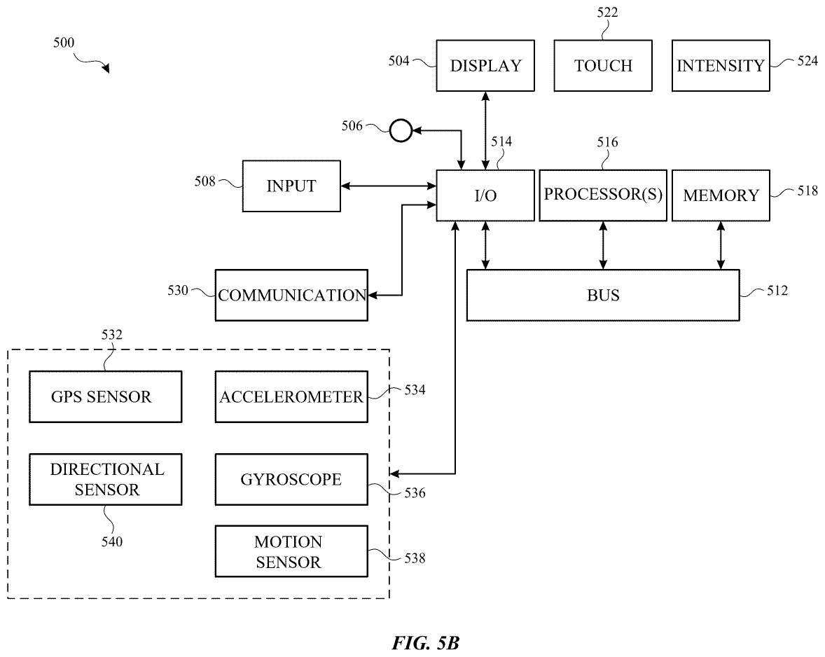

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including method 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6M illustrate exemplary user interfaces for providing reminders based on electronic communications (e.g., phone calls, video calls, voice messages, and/or text messages), in accordance with some embodiments. The user interfaces in these figures are used to illustrate the processes described below, including the processes in FIG. 7.

FIG. 6A illustrates computer system 600 (e.g., a mobile phone device), which includes display 602 with a touch-sensitive surface. In some embodiments, computer system 600 includes other input and/or output devices, such as cameras, microphones, gesture input devices, air gesture input devices, gaze input devices, hardware input devices (e.g., hardware buttons, switches, dials, and/or peripherals such as a stylus, keyboard, and/or mouse), sensors, speakers, and/or tactile output generators. In some embodiments, the methods described herein using computer system 600 are implemented using (e.g., in conjunction with computer system 600) one or more user devices (e.g., mobile phones, tablet computers, laptop computers, and/or wearable electronic devices (e.g., smart watches, head-mounted devices, headsets, and/or headphones) and/or peripheral devices (e.g., external storage drives, microphones, speakers, and/or hardware input or output devices)).

As illustrated in FIG. 6A, computer system 600 displays user interface 606, a user interface of a communication service or application installed on computer system 600, such as a phone application. In region 606A (e.g., the portion of user interface 606 labeled with the header “Recents”), user interface 606 includes a log of recent communications that includes communication items 608A-608E, which indicate information about respective incoming and outgoing communications (e.g., phone calls, video calls, and/or voicemails). For example, communication item 608A represents an incoming missed phone (e.g., audio) call at 9:41 AM from the contact named Rory J., indicated by the text label of the contact name and a contact icon (e.g., graphic representation) for the contact Rory J., displayed on the left side of communication item 608A, which resulted in a voicemail left for a user of computer system 600, indicated by the text, “Calling to see if you're free this Sunday,” transcribing and/or summarizing the voicemail contents. As another example, communication item 608B represents a recent outgoing video call placed to the contact named Johnny A at 9:09 AM. As illustrated in FIG. 6A, communication items 608A-608E are ordered in reverse chronological order within user interface 606, with the most recent communication item (608A) listed first, followed by communication items for progressively older incoming and outgoing calls. User interface 606 also includes other controls for using the communication service/application, such as the navigation menu displayed at the bottom of user interface 606, which includes user interface object 606B for accessing the communication log, user interface object 606C for accessing the user of computer system 600's saved contacts, and user interface object 606D for accessing a keypad user interface to enter a phone number to call.

At FIG. 6A, computer system 600 detects input 610, a gesture input directed to communication item 608A via the touch-sensitive surface of display 602 and swiping to the left. As illustrated in FIG. 6B, in response to detecting input 610, computer system 600 displays reminder option 612A, a selectable user interface object with a clock icon, and delete option 612B, a selectable user interface object with a trash can icon, in user interface 606 to the right of communication item 608A. For example, in response to detecting input 610, computer system 600 animates communication item 608A sliding to the left to extend partially off of display 602 and displays reminder option 612A and delete option 612B in the space previously occupied by communication item 608A. Selecting reminder option 612A initiates a process for creating a reminder to call the contact Rory J. back at a later time (e.g., a callback reminder), as described herein with respect to FIGS. 6C-6E, and selecting delete option 612B removes communication item 608A from display in user interface 606.

In response to detecting, at FIG. 6B, input 614 selecting reminder option 612A (e.g., a tap directed to reminder option 612A via the touch-sensitive surface of display 602), at FIG. 6C, computer system 600 displays reminder menu 616 for creating a callback reminder based on the call represented by communication item 608A (e.g., the missed call from the contact Rory J.). As illustrated in FIG. 6C, reminder menu 616 partially overlays user interface 606 at and/or near the location of communication item 608A and includes menu items corresponding to creating callback reminders with different reminder times, indicated by the text “Remind me in 1 hour,” “Remind me tonight,” “Remind me tomorrow,” and “Remind me later . . . ”. The first three options in reminder menu 616 (e.g., “. . . in 1 hour,” “. . . tonight,” and “. . . tomorrow”) correspond to different preselected times at which computer system 600 will deliver the callback reminder. For example, in response to detecting input 618A, directed to the option in reminder menu 616 labeled “Remind me tonight,” computer system 600 creates a callback reminder for Rory J. with a callback time of 5:00 PM, a time corresponding to “tonight” on the same day the reminder was created, as illustrated in FIG. 6E.

Alternatively to selecting one of the preselected times, in response to detecting input 618B directed to the option in reminder menu 616 labeled “Remind me later . . . ,” at FIG. 6D, computer system 600 displays user interface 620 overlaying user interface 606. User interface 620 includes date field 620A for selecting a reminder date and time field 620B for selecting a custom reminder time from a less-restricted range of options than the preselected reminder times represented by the first three items in reminder menu 616. For example, in response to receiving a set of inputs including input 622A directed to date field 620A and input 622B directed to time field 620B, computer system 600 provides options for dates and times other than 11:09 AM today (e.g., in an hour), 5:00 PM today (e.g., tonight), and 10:09 tomorrow (e.g., in 24 hours). In some embodiments, user interface 620 provides additional options for customizing information associated with the reminder, such as a title, notes, contact information, tags, and/or organizational information. For example, as illustrated in FIG. 6D, the title and contact information associated with the reminder are automatically populated with the title “Call back Rory J.,” and the contact information for Rory J. based on communication item 608A, but user interface 620 provides title field 620C for editing the title and contact information field 620D for editing the contact information. In response to detecting input 622C directed to finish option 620E, computer system 600 creates a reminder to call back Rory J. using the options selected via user interface 620.

At FIG. 6E, after creating the callback reminder for Rory J. (e.g., either in response to input 618A at FIG. 6C or in response to input 622C at FIG. 6D), computer system 600 displays user interface 606 (e.g., the user interface of the communication service or application) with reminder item 624A, corresponding to the callback reminder for Rory J. As illustrated in FIG. 6E, computer system 600 displays reminder item 624A in region 606E, which is labeled with the header “Reminders” and inserted above region 606A, creating a new section for callback reminders near the top of user interface 606. For example, region 606A is moved down within user interface 606, such that communication item 608E (e.g., the communication item displayed at the bottom of display 602 in FIG. 6A) is no longer visible without scrolling down within user interface 606. As illustrated in FIG. 6E, reminder item 624A includes information about the created reminder: the text “Rory J.” and the same contact icon for the contact Rory J. that is displayed with communication item 608A, indicating the contact to be called back; the text “5:00 PM,” indicating the selected reminder time; and the text “Mobile” and a selectable option with a phone icon (e.g., described further with respect to FIG. 6G), indicating that the reminder is to return a missed audio call from the contact Rory J.'s mobile phone number.

FIGS. 6E-6G illustrate computer system 600 creating a second callback reminder via user interface 606. As illustrated in FIG. 6E, user interface 606 includes communication item 608F, which represents a missed call from a phone number (e.g., “+1 (555)234-5678”) that is not associated with a saved contact. For example, communication item 608F is displayed with an icon representing an unknown contact. The call represented by communication item 608F was received after the call from Rory J., and is thus displayed above communication item 608A within region 606A. At FIG. 6E, computer system 600 detects input 626, a gesture input swiping left across communication item 608F. As illustrated in FIG. 6F, in response to input 626, computer system 600 displays reminder option 612A and delete option 612B and, in response to input 628A directed to reminder option 612A, displays reminder menu 616, as described above with respect to FIGS. 6B-6C. In response to detecting input 628B directed to the “Remind me tomorrow” menu item in reminder menu 616, computer system 600 creates a reminder to return the call from the unsaved phone number to be provided the next day.

At FIG. 6G, after creating the callback reminder for the missed call from the unsaved phone number, computer system 600 displays user interface 606 with a new reminder item, reminder item 624B, displayed in region 606E (e.g., the “Reminders” section) with reminder item 624A. As illustrated in FIG. 6G, reminder item 624B is displayed with the associated phone number, the icon representing the unknown contact, the reminder time (e.g., the text “Tomorrow”), and a selectable option with a phone icon. Reminder item 624A and reminder item 624B are ordered within region 606E based on the associated reminder times, for instance, presenting the reminder items in chronological order, such that reminder item 624A, which has the closer reminder time (e.g., 5:00 PM today), is displayed above reminder item 624B.

While displaying reminder item 624A and reminder item 624B in user interface 606, in response to detecting an input directed to a displayed reminder item, computer system 600 initiates a process for placing a call (e.g., an audio or video call) to the contact associated with the reminder item. For example, as illustrated in FIG. 6G, in response to detecting input 630 directed to the call icon displayed with reminder item 624B, computer system 600 initiates a call to the phone number indicated by reminder item 624B (e.g., the phone number from which the call associated with communication item 608F was received). In some embodiments, the process for placing the call (e.g., the callback) to the contact uses the same mode of communication used by the communication upon which the reminder was based, for instance, returning an audio call using an audio call process and/or returning a video call using a video call process by default.

At FIG. 6H, computer system 600 displays user interface 632, a user interface for a reminder application installed on computer system 600 that provides a list of active (e.g., incomplete and/or upcoming) reminders, represented by reminder items 632A-632D. As illustrated in FIG. 6H, after computer system 600 creates the callback reminders via user interface 606 as described with respect to FIGS. 6A-6F, the list of active reminders includes reminder item 632A corresponding to the callback reminder for Rory J. and reminder item 632D corresponding to the callback reminder for the unknown number. In user interface 632 for the reminder application, reminder item 632A and reminder item 632D (e.g., the callback reminders) are displayed along with reminder items for non-callback tasks, such as reminder item 632B (e.g., a reminder to take out the trash) and reminder item 632C (e.g., a reminder to mail a birthday gift), and the reminder items in user interface 632 are ordered in chronological order, so reminder item 632A and reminder item 632D for the callback reminders are integrated into the list based on the reminder time. As illustrated in FIG. 6H, reminder item 632A is displayed with contact indication 634A, representing the contact Rory J., and reminder item 632D is displayed with contact indication 634B, representing the unknown phone number. In response to detecting a selection of a callback reminder displayed in user interface 632 for the reminder application, initiates a process for placing a call (e.g., an audio or video call) to the contact associated with the reminder item. For example, as illustrated in FIG. 6H, in response to detecting input 636 directed to contact indication 634B, computer system 600 initiates a call to the phone number indicated by reminder item 632D. Accordingly, in addition to displaying callback reminders and providing options for initiating callbacks via user interface 606, computer system 600 displays callback reminders and provides options for initiating callbacks via user interface 632.

After initiating the process for placing a call to the number associated with communication item 608F, for example, in response to input 630 via user interface 606 at FIG. 6G or in response to input 636 via user interface 632 at FIG. 6H, computer system 600 marks the callback reminder created at FIGS. 6E-6F as completed (e.g., removes the callback reminder from the active state). In some embodiments, computer system 600 marks the callback reminder as completed only if the call was successfully completed. For example, computer system 600 marks the reminder as completed if the call to the unknown number successfully connects, either by being accepted (e.g., picked up) by the party of the unknown number or by connecting to a voicemail system for the unknown number, and/or if the call to the unknown number lasts at least a threshold duration after connecting, such as at least 3 seconds, 5 seconds, 10 seconds, or another duration of time that is likely long enough for the user to speak to and/or leave a message for the remote party.

After computer system 600 creates the callback reminders via user interface 606 as described with respect to FIGS. 6A-6F, in some embodiments, computer system 600 provides a reminder output at the corresponding reminder time. For example, at 5:00 PM, computer system 600 generates one or more reminder outputs reminding the user to call the contact Rory J., such as displaying a notification, providing a spoken (e.g., synthesized speech) reminder, playing an audio notification chime, and/or generating a tactile notification output (e.g., a vibration). In some embodiments, in response to detecting an input responding to the reminder output(s), such as an input selecting a displayed reminder notification via a touch-sensitive surface of display 602, computer system 600 initiates a process for placing a call to Rory J. In some embodiments, computer system 600 does not provide a reminder output at the corresponding reminder time. For example, if computer system 600 is in a low-interruption or “do not disturb” mode at 5:00 PM or if the callback reminder for Rory J. is no longer in an active (e.g., incomplete) state at 5:00 PM (e.g., as described further below), computer system 600 refrains from providing a reminder notification.

At FIG. 6I, the callback reminder associated with the call from the unknown number has been marked as completed (e.g., as described with respect to FIGS. 6G-6H), but the callback reminder item associated with the call from Rory J. remains in an active (e.g., incomplete and/or pending) state. For example, even if computer system 600 had provided one or more reminder notifications at the reminder time of 5:00 PM, as of the time at FIG. 6I (e.g., 6:00 PM), computer system 600 has not initiated a process for calling Rory J. (e.g., as described with respect to the FIGS. 6G-6H) and/or detected another communication that satisfies criteria for completing the callback to Rory J., such as the communications described in further detail below with respect to FIG. 6L. Accordingly, at FIG. 6I, computer system 600 no longer displays reminder item 624B in region 606E of user interface 606, but continues to display reminder item 624A in region 606E of user interface 606. As illustrated in FIG. 6I, because the reminder time of 5:00 PM has passed, computer system 600 updates the appearance of reminder item 624A, for example, displaying the reminder time in red, with highlighting, and/or with other visual characteristics indicating that the callback reminder for Rory J. is now overdue. Likewise, in some embodiments, if computer system 600 displayed user interface 632 (e.g., the user interface for the reminder application), reminder item 632A for the callback reminder for Rory J. would be displayed in the reminder list, while reminder item 632D for the callback reminder to the unknown number would be removed and/or updated to visually indicate that the corresponding reminder was marked as completed (e.g., displaying reminder item 632D with a checkmark icon, struck-through text, a grayed-out appearance, and/or moved to a completed reminders section of user interface 632).

At FIG. 6I, computer system 600 detects input 638A, a gesture input swiping a short (e.g., less than a threshold) distance to the left across reminder item 624A. In response to detecting input 638A, at FIG. 6J, computer system 600 displays reminder edit option 640A and reminder delete option 640B to the right of reminder item 624A, for example, animating reminder item 624A sliding to the left to reveal reminder edit option 640A and reminder delete option 640B (e.g., as described above with respect to sliding communication item 608A to the left in response to input 610). Selecting reminder edit option 640A initiates a process for modifying the previously-created callback reminder for Rory J., as described below with respect to FIG. 6K, and selecting reminder delete option 640B deletes the callback reminder represented by reminder item 624A. In some embodiments, after deleting the callback reminder represented by reminder item 624A, computer system 600 will not display reminder item 624A in user interface 606 or reminder item 632D in user interface 632. Alternatively, at FIG. 6I, computer system 600 detects input 638B, a gesture input swiping a longer (e.g., at least the threshold) distance to the left across reminder item 624A, and, in response, computer system 600 deletes the callback reminder represented by reminder item 624A. As illustrated in the top panel of FIG. 6J, in some embodiments, as the distance traveled by the left swipe gesture of input of 638B lengthens, computer system 600 displays reminder delete option 640B expanding, indicating that continuing to swipe will result in the deletion of the associated reminder.

In response to detecting input 642 directed to reminder edit option 640A at FIG. 6J, computer system 600 displays reminder edit menu 644 for modifying the previously-created callback reminder for Rory J. As illustrated in FIG. 6K., reminder edit menu 644 partially overlays user interface 606 at and/or near the location of reminder item 624A and includes menu items labeled “Edit reminder” and “Mark as completed.” For example, in response to detecting input 646A directed to the “Edit reminder” menu item, computer system 600 displays user interface 620, allowing the user to change the properties of the callback reminder (e.g., as described with respect to FIG. 6D). For example, in response to detecting input 646B directed to the “Mark as completed” menu item, computer system marks the callback reminder for Rory J. as completed (e.g., as though computer system 600 had successfully completed a call to the contact Rory J.). For example, in response to detecting input 646B, computer system 600 removes reminder item 624A from user interface 606 (e.g., as described below with respect to FIG. 6M) and, when displaying user interface 632 (e.g., the reminder user interface), refrains from displaying reminder item 632A and/or displays reminder item 632A with an updated appearance (e.g., as described above with respect to reminder item 632D for the completed callback to the unknown number).

In addition to marking a callback reminder as complete in response to initiating a callback via a provided reminder item (e.g., as described above with respect to reminder item 624B in FIG. 6G and with respect to reminder item 632D in FIG. 6H) and in response to detecting an input marking the reminder as complete (e.g., as described above with respect to input 646B at FIG. 6K), in some embodiments, computer system 600 marks a callback reminder as complete in response to detecting other types of communication with the contact associated with the callback reminder. For example, as illustrated in FIG. 6K, computer system 600 detects input 648 directed to communication item 608A, the representation of the missed call from the contact Rory J., and, in response, initiates a process for placing a call to the contact Rory J. As illustrated in panel (I) of FIG. 6L, computer system 600 marks the callback reminder for Rory J. as complete when the call placed in response to input 648 successfully connects (e.g., either being picked up by the contact Rory J. or going to Rory J.'s voicemail) and lasts at least a threshold duration (e.g., 5 seconds), as indicated by active call user interface 650. As another example, as illustrated in panel (II) of FIG. 6L, computer system 600 receives an incoming call from the contact Rory J., indicated by incoming call user interface 652, and marks the callback reminder for Rory J. as complete in response to detecting input 654, an input accepting (e.g., picking up) the incoming call from Rory J. via incoming call user interface 652. As another example, as illustrated in panel (III) of FIG. 6L, computer system 600 detects that the user has sent, via messaging user interface 656, text message 658 to the contact Rory J, reading, “I got your message. I'm not free this Sunday, but how about Wednesday?” Based on a determination (e.g., using semantic and/or natural-language processing techniques) that text message 658 to the contact Rory J. addresses the request left in the voicemail associated with communication item 608A (e.g., indicated by the transcription/summary “Calling to see if you're free this Sunday”), thus serving as a suitable proxy to calling Rory J., back, computer system 600 marks the callback reminder for Rory J. as complete.

At FIG. 6M, after marking the callback reminder for Rory J. as complete in response to input 646B and/or detecting any of the communications described with respect to FIGS. 6K-6L, computer system 600 displays user interface 606 without reminder item 624A. As illustrated in FIG. 6M, as the callback reminders created as described with respect to FIGS. 6A-6F have all been removed (e.g., marked as completed and/or deleted), computer system 600 displays user interface 606 without region 606E, removing the “Reminders” header and extending region 606A (e.g., the call log section labeled “Recents”) up, for instance, again occupying the portion of display 602 that region 606A occupied at FIG. 6A. As illustrated in FIG. 6M, although reminder item 624A and reminder item 624B are removed from user interface 606, the representations of the communications upon which the reminders were based (e.g., communication item 608A and communication item 608F) are still provided in region 606A as part of the call log (e.g., along with representations of the communications that completed the callback reminders, if applicable, such as communication item 608G and/or communication item 608H). In some embodiments, as described above, after marking the callback reminder for Rory J. as complete, when displaying user interface 632 (e.g., the reminder user interface), computer system refrains from displaying reminder item 632A and/or displays reminder item 632A with an updated appearance (e.g., as described above with respect to reminder item 632D for the completed callback to the unknown number).

FIG. 7 is a flow diagram illustrating a method for providing reminders based on electronic communications using a computer system in accordance with some embodiments. Method 700 is performed at a computer system (e.g., including one or more mobile phones, personal computers, laptops, tablets, smart watches, head-mounted displays, other wearable devices, and/or other electronic devices) (e.g., 100, 300, 500, and/or 600) that is in communication with one or more display generation components (e.g., display controllers; touch-sensitive display systems; displays (e.g., integrated and/or connected), 3D displays, transparent displays, projectors, and/or heads-up displays) and one or more input devices (e.g., touch-sensitive surfaces, hardware input devices (e.g., a hardware button, switch, dial, stylus, keyboard, and/or mouse), cameras, microphones, gesture input devices, air gesture input devices, and/or gaze input devices): In some embodiments, the computer system is optionally in communication with one or more output devices such as audio controllers, speakers, indicator lights, and/or haptic output generators. Some operations in method 700 are, optionally, combined, the orders of some operations are, optionally, changed, and some operations are, optionally, omitted.

The devices, methods, and/or computer-readable storage mediums described below enhance the operability of the device and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Reducing the number of inputs needed to perform an operation (such as by providing options for creating the reminder via a communication user interface without requiring a user to navigate to a user interface for a reminder service/application, displaying a representation of the reminder within the communication user interface (e.g., without requiring a user to navigate to a user interface for a reminder service/application), and creating a reminder associated with a selected communication without requiring the user to manually input information related to the communication, such as a callback number) enhances the operability of the device by reducing the number of inputs and time required to perform a particular operation, reducing energy usage by the device. Providing improved feedback (such as by intuitively displaying a representation of a created reminder within the communication user interface and by displaying the representation of the created reminder in a separate section from the representations of communications included in the communication user interface) enhances the operability of the device by reducing accidental and mistaken inputs, reducing energy usage by the device.

While displaying (702), via the one or more display generation components (e.g., 602), a communication user interface (e.g., 606) (e.g., a call log user interface, a phone/video call user interface that includes a record of recent calls, and/or a voicemail user interface) that includes one or more representations of one or more respective communications (e.g., 608A-608H) (e.g., past calls and/or voicemails), the computer system detects (704), via the one or more input devices, a first set of one or more inputs (e.g., 610 and/or 626) directed to a representation of a first communication (e.g., as illustrated in FIGS. 6A and/or 6E). For example, the first set of one or more inputs includes a particular gesture or sequence of gestures directed to the representation of the first communication on a touch-sensitive surface of a display, such as a swipe in a particular direction, a long press, and/or another input or sequence of inputs. For example, the communication user interface includes a phone user interface, a video call user interface, a chat user interface, a teleconferencing user interface, a messaging user interface, a voicemail user interface, and/or another user interface that includes representations of communications between the user of the computer system and one or more remote parties (e.g., users of remote computer systems).

In response to detecting the first set of one or more inputs directed to the representation of the first communication (e.g., 608A-608H), the computer system displays (706), via the one or more display generation components, a reminder user interface option (e.g., 612A) (e.g., a selectable graphical element, button, icon, and/or affordance) (e.g., as illustrated in FIGS. 6B and/or 6F). For example, the reminder user interface option is displayed in the communication user interface at a location that corresponds to the representation of the first communication (e.g., next to, overlaying, replacing, and/or partially replacing the representation of the first communication). In some embodiments, the computer system initially displays a compact version of the reminder user interface option (e.g., a compact reminder button). In some embodiments, in response to detecting the first set of one or more inputs directed to the representation of the first communication, the reminder user interface option is displayed with one or more additional options for interacting with the first communication, such as a callback button (e.g., for initiating a call to the contact associated with the first communication) and/or a delete button (e.g., for removing the representation of the first communication from the communication user interface).

After (e.g., in response to) detecting a second set of one or more inputs (e.g., 614, 618A, 618B, 622A, 622B, 622C, 626, and/or 628) that corresponds to a request to create a reminder (e.g., a callback reminder) associated with the first communication, wherein the second set of one or more inputs includes an input (e.g., 614 and/or 626) directed to the reminder user interface option (e.g., as illustrated in FIGS. 6B and/or 6F), the computer system displays (708), via the one or more display generation components, a representation (e.g., 624A and/or 624B) of a first reminder associated with the first communication. In some embodiments, the reminder is initially displayed in response to detecting the request to create the reminder, and the reminder is displayed when viewing the communication user interface at a later time (e.g., in response to detecting a request to re-display and/or re-open the communication user interface after navigating away to another user interface). In some embodiments, in response to the second set of one or more inputs that corresponds to the request to create the reminder associated with the first communication, the computer system creates the first reminder, for instance, storing a set of information (e.g., a reminder object) associated with the first reminder. In some embodiments, upon creating the first reminder, a status of the first reminder is active (e.g., pending) until the first reminder is marked as complete or deleted, as described further below. The representation (e.g., 624A and/or 624B) of the first reminder associated with the first communication is displayed in a first region (e.g., 606E) of the communication user interface (e.g., 606), and the one or more representations (e.g., 608A-608H) of the one or more respective communications are displayed in a second region (e.g., 606A) of the communication user interface (e.g., 606) that is different from (e.g., does not overlap with; is visually distinct from; is spaced apart from; and/or is separated by a border, header, and/or other user interface element from) the first region of the communication user interface (e.g., as illustrated in FIGS. 6E-6G and/or 6I-6K). For example, the computer system displays one or more reminders in a separate reminders section that is displayed concurrently with a call log/voicemail section. For example, at a time when both the first region and the second region of the user interface are displayed, the first region and the second region occupy non-overlapping regions of the display. In some embodiments, the first region and the second region are visually distinguished within the user interface, for instance, by displaying the two regions with different headers, displaying one or more border/framing elements visually separating the regions from each other (e.g., and/or from other regions of the user interface), and/or displaying a gap between the contents of the two regions (e.g., and/or between the contents of the two regions and other regions of the user interface). In some embodiments, the computer system does not display representations of respective reminders (e.g., a first type of content) in the second region and the computer system does not display the representations of the respective communications (e.g., a second type of content) in the first region. In some embodiments, if the communication user interface does not include any reminders when the second set of one or more inputs is detected, the computer system updates the communication user interface to include a section header (e.g., a “Reminders” header) in the first region (e.g., the computer system updates the communication user interface to include a new Reminders section for the newly-created reminder).

In some embodiments, in response to detecting the input (e.g., 614 and/or 626) directed to the reminder user interface option (e.g., 612A), the computer system displays, via the one or more display generation components, a plurality of reminder time options (e.g., 616) (e.g., a menu for selecting a time/deadline for a reminder), wherein the second set of one or more inputs includes an input (e.g., 618A, 618B, and/or 628) directed to a respective reminder time option (e.g., a selectable graphical element, button, icon, and/or affordance) of the plurality of reminder time options (e.g., as illustrated in FIGS. 6C and/or 6F). In some embodiments, the plurality of reminder time options partially overlays the communication interface, for example, near the representation of the first communication and/or the reminder user interface option. In some embodiments, one or more of the plurality of reminder time options are associated with preselected reminder time options, such as options for a reminder in one hour, later the same day, and/or the next day. In some embodiments, the plurality of reminder time options includes an option for selecting a reminder time not included in the preselected reminder time options (e.g., an option that opens a user interface for freely selecting a callback time).

In some embodiments, the respective reminder time option of the plurality of reminder time options is associated with a respective reminder time (e.g., a preselected and/or default callback time option), and displaying the representation (e.g., 624A and/or 624B) of the first reminder associated with the first communication is performed in response to detecting the input directed to the respective reminder time option (e.g., selecting one of the reminder times creates the reminder) (e.g., as described with respect to input 618A at FIG. 6C and input 628 at FIG. 6F). In some embodiments, the representation of the first reminder includes an indication of the respective reminder time (e.g., the reminder is displayed in the communication interface with the deadline). In some embodiments, the indication of the respective reminder time is displayed with a first appearance when the respective reminder time has not yet passed, and the indication of the respective reminder time is displayed with a second appearance when the respective reminder time has passed (e.g., the appearance of the reminder time changes to indicate if the callback is overdue).

In some embodiments, the first set of one or more inputs directed to the representation of the first communication includes a gesture input (e.g., 610 and/or 626) (e.g., a touch gesture input detected via a touch-sensitive surface of a display) moving in a respective direction with respect to the representation of the first communication (e.g., as illustrated in FIGS. 6A and/or 6E). For example, the first set of one or more inputs includes a left (e.g., or right) swipe across the representation of the first communication on the display. In some embodiments, displaying the reminder user interface option includes displaying, via the one or more display generation components, an animation of (e.g., animating) the representation of the first communication moving in the respective direction to reveal the reminder user interface option(e.g., 612A) (e.g., as described with respect to FIGS. 6A-6B and/or 6E-6F). For example, the reminder user interface option is displayed at a location within the communication user interface that was occupied by a portion of the representation of the first communication prior to animating the representation of the first communication sliding in response to the gesture input.

In some embodiments, the first region of the communication user interface (e.g., 606E) (e.g., the region in which the first reminder associated with the first communication is displayed) is above (e.g., with respect to the orientation of the communication user interface) the second region of the communication user interface (e.g., 606A) (e.g., the region in which the one or more representations of the one or more respective communications are displayed).

In some embodiments, while displaying the communication user interface, the computer system displays, via the one or more display generation components, a representation of a second reminder associated with a second communication concurrently with displaying the representation of the first reminder associated with the first communication in the first region of the communication user interface (e.g., 624A and 624B, as illustrated in FIG. 6G) (e.g., multiple pending callback reminders are concurrently displayed in the first region of the communication user interface). In some embodiments, while displaying the communication user interface, the computer system detects, via the one or more input devices, a set of one or more inputs directed to a representation of a second communication of the one or more respective communications and, in response to detecting the set of one or more inputs directed to the representation of the second communication, displays, via the one or more display generation components, the reminder user interface option, wherein the representation of the second reminder is displayed in response to detecting a set of one or more inputs including an input directed to the reminder user interface option (e.g., the second reminder is created in the same manner as the first reminder).

In some embodiments, the representation (e.g., 624A) of the first reminder associated with the first communication is associated with a first reminder time (e.g., a callback time and/or deadline), the representation (e.g., 624B) of the second reminder associated with the second communication is associated with a second reminder time, and displaying the representation of the second reminder associated with the second communication concurrently with displaying the representation of the first reminder associated with the first communication includes ordering the representation of the second reminder associated with the second communication and the representation of the first reminder associated with the first communication within the first region (e.g., 606E) of the communication user interface based on first reminder time and the second reminder time (e.g., as illustrated in FIG. 6G) (e.g., with respect to each other and with respect to the reminder times of any other concurrently-displayed reminders). For example, the reminder time is a callback time/deadline selected by the user when requesting creation of the reminder (e.g., and not the time the reminder was created and/or the timestamp of the associated communication). For example, the reminders are ordered chronologically, so the reminder with the closest reminder time is ordered first. In some embodiments, the order is based on other factors in addition to the respective reminder times, e.g., for multiple reminders with the same reminder time, ordering alphabetically based on contact name and/or chronologically based on the time of the associated communication. In some embodiments, the representation of the first reminder and the representation the second reminder are displayed with an indication of the respective reminder times.

In some embodiments, the representation (e.g., 624A and/or 624B) of the first reminder associated with the first communication (e.g., displayed in the first region of the communication user interface) includes a graphical representation (e.g., an icon, photo, graphic, and/or text object (e.g., monogram)) of a contact (e.g., a saved contact, an identified contact, a phone number, and/or an account identifier) associated with the first communication (e.g., as illustrated in FIGS. 6E-6G and/or 6I) (e.g., a graphical representation of the other party/parties to the call). In some embodiments, the representation (e.g., 608A-608H) of the first communication (e.g., displayed in the communication user interface) includes the graphical representation of the contact associated with the first communication. For example, the reminder uses the same graphical representation of the contact that was displayed with the representation of the first communication when the reminder was set up. For example, as illustrated in FIG. 6E, reminder item 624A includes the same icon as communication item 608A, and as illustrated in FIG. 6G, reminder item 624B includes the same icon as communication item 608F.

In some embodiments, while displaying the representation (e.g., 624A and/or 624B) of the first reminder associated with the first communication, the computer system detects, via the one or more input devices, a fourth set of one or more inputs (e.g., 630) directed to (e.g., selecting) the representation of the first reminder associated with the first communication, and, in response to detecting the fourth set of one or more inputs directed to the representation of the first reminder associated with the first communication, the computer system initiates a communication session (e.g., placing an audio and/or video call) with a contact (e.g., a saved contact, an identified contact, a phone number, and/or an account identifier) associated with the first communication (e.g., as described with respect to FIG. 6G). In some embodiments, the representation (e.g., 624A and/or 624B) of the first reminder associated with the first communication includes a first selectable user interface object (e.g., a callback button) (e.g., a selectable graphical element, button, icon, and/or affordance), and the fourth set of one or more inputs includes an input (e.g., 630) (e.g., a touch input detected via a touch-sensitive surface of a display) directed to (e.g., selecting) the first selectable user interface object (e.g., as illustrated in FIG. 6G).

In some embodiments, while displaying the representation (e.g., 624A and/or 624B) of the first reminder associated with the first communication, the computer system detects, via the one or more input devices, a fifth set of one or more inputs (e.g., 638A and/or 638B) directed to the representation of the first reminder associated with the first communication (e.g., as illustrated in FIG. 6I). For example, the first gesture input is a short swipe left across the representation of the first reminder. In some embodiments, in response to detecting the fifth set of one or more inputs and in accordance with a determination that the fifth set of one or more inputs includes a first gesture input (e.g., 638A) (e.g., a touch gesture input detected via a touch-sensitive surface of a display) that moves in a first direction and by less than a first threshold distance (e.g., and greater than a second threshold distance), the computer system displays, via the one or more display generation components: a first option (e.g., 640A) (e.g., a selectable graphical element, button, icon, and/or affordance) for modifying the first reminder associated with the first communication; and a second option (e.g., 640B) (e.g., a selectable graphical element, button, icon, and/or affordance) for deleting the first reminder associated with the first communication. In some embodiments, in response to detecting an input directed to the first option for modifying the first reminder, the computer system displays options for changing one or more values associated with the first reminder (e.g., editing the callback time, number, contact, and/or other reminder information) and/or options for marking the reminder as completed. In some embodiments, in response to detecting an input directed to the second option for deleting the first reminder, the computer system ceases displaying the representation of the first reminder in the communication user interface. In some embodiments, the first and second option are displayed with at least a portion of the representation of the first reminder. For example, the computer system animates the representation of the first reminder sliding in the direction of the gesture to reveal the two options.

In some embodiments, in response to detecting the fifth set of one or more inputs and in accordance with a determination that the fifth set of one or more inputs includes a second gesture input (e.g., 638B) (e.g., a touch gesture input detected via a touch-sensitive surface of a display) that moves in the first direction and by at least the first threshold distance, the computer system ceases displaying the representation of the first reminder associated with the first communication (e.g., as described with respect to FIG. 6J) (e.g., deleting the first reminder). For example, the second gesture input is a long swipe left across the representation of the first reminder. In some embodiments, prior to the magnitude of the gesture input reaching the first threshold distance, the computer system displays the first and second option and/or displays a visual indication (e.g., a delete symbol and/or graphic) that indicates that swiping further will delete the first reminder.

In some embodiments, the first communication is associated with a first contact (e.g., a saved contact, an identified contact, a phone number, and/or an account identifier representing a remote party of the first communication). In some embodiments, after displaying the representation of the first reminder associated with the first communication, the computer system detects a third communication (e.g., an incoming or outgoing audio call, video call, or message) associated with the first contact (e.g., as illustrated in FIG. 6L) (e.g., the first contact is a remote party of the third communication). In some embodiments, in response to detecting the third communication associated with the first contact and in accordance with a determination that the third communication associated with the first contact satisfies at least one completion criterion, the computer system updates a status of the first reminder associated with the first communication to a completed status (e.g., as described with respect to FIGS. 6G-6I and/or 6L-6M) (e.g., marking the first reminder as done). In some embodiments, in accordance with a determination that the third communication associated with the first contact does not satisfy at least one completion criterion, the computer system foregoes updating the status of the first reminder associated with the first communication to the completed status. In some embodiments, the at least one completion criterion is satisfied when the third communication is initiated by selecting the first reminder via the communication user interface (e.g., or another user interface in which a representation of the first reminder is displayed, such as the reminder user interface discussed below).

In some embodiments, the third communication associated with the first contact includes an outgoing communication from a user of the computer system to the first contact (e.g., panel (I) of FIG. 6L) (e.g., the computer system determines that the user of the computer system has placed an audio and/or video call and/or sent a message to the first contact) or an incoming communication from the first contact to the user of the computer system (e.g., panel (II) of FIG. 6L) (e.g., the computer system determines that the user of the computer system has received an audio and/or video call and/or a message from the first contact).

In some embodiments, the at least one completion criterion is satisfied when the third communication associated with the first contact includes initiating an active communication session with the first contact (e.g., panel (I) and/or panel (II) of FIG. 6L) (e.g., the incoming or outgoing call is accepted (e.g., picked up/answered) by the receiving party, establishing the active communication session). For example, if the user calls the first contact and the first contact picks up or if the first contact calls the user and the user picks up, the reminder is marked as completed, but if the user calls the first contact and the first contact does not pick up or if the first contact calls the user and the user does not pick up, the reminder is not marked as completed.

In some embodiments, the at least one completion criterion is satisfied when the third communication associated with the first contact includes an outgoing communication from a user of the computer system to the first contact of at least a threshold duration (e.g., as described with respect to panel (I) of FIG. 6L) (e.g., 3 seconds, 5 seconds, 10 seconds, or 15 seconds). For example, the threshold duration is a sufficiently long duration for the user to have spoken with and/or left a voicemail for the first contact. In some embodiments, the duration of the third communication is measured from the time an active communication session is initiated (e.g., from when the first contact accepts the incoming call) and/or from the time the user of the computer system begins recording a voicemail for the first contact.

In some embodiments, the at least one completion criterion is satisfied when the third communication associated with the first contact includes content of a first type (e.g., as described with respect to panel (III) of FIG. 6L) (e.g., speech and/or text corresponding to particular information, topics, and/or requests). For example, the content of the first type is content that responds to and/or addresses the first communication. In some embodiments, the computer system determines that the third communication includes the content of the first type based on analysis of the first communication, for example, using speech-and/or natural language-processing techniques to identify information, topics, and/or requests referenced in the communication. In some embodiments, the at least one completion criteria is satisfied in accordance with a determination (e.g., using speech-and/or natural language-processing techniques) that the first communication includes respective content (e.g., speech corresponding to particular information, topics, and/or requests), wherein the content of the first type of content references the respective content (e.g., as described with respect to panel (III) of FIG. 6L). For example, the first type of content is content that responds to and/or addresses the information, topics, and/or requests included in the first communication. In some embodiments, the third communication is a different type (e.g., mode) of communication than the first communication, such as a text message (e.g., the third communication) that responds to a question posed in a voicemail (e.g., the first communication).

In some embodiments, while displaying the communication user interface (e.g., 606) after updating a status of the first reminder associated with the first communication to a completed status (e.g., after the first reminder is marked as done), the computer system foregoes displaying the representation of the first reminder associated with the first communication (e.g., as described with respect to FIGS. 6I and/or 6M). In some embodiments, if there are no pending callback reminders (e.g., reminders that were displayed in the communication user interface and have not been marked as completed or deleted), the computer system foregoes displaying one or more graphical elements corresponding to the first region of the user interface (e.g., the computer system removes the “Reminders” section header and/or other indicia of the reminder section) and/or displays the one or more representations of the one or more respective communications in a larger region of the communication user interface (e.g., the recent call log expands into the region previously occupied by the reminders) (e.g., as illustrated in FIG. 6M).

In some embodiments, after displaying the representation of the first reminder associated with the first communication in the first region (e.g., 606E) of the communication user interface (e.g., 606) (e.g., after creating the first reminder via the communication user interface as described above), the computer system displays, via the one or more display generation components, a reminder user interface (e.g., 632) (e.g., a user interface for a reminder application) that is different from the communication user interface. In some embodiments, the reminder user interface does not include the one or more representations of the one or more respective communications (e.g., the reminder user interface is not a call log user interface, a phone/video call user interface that includes a record of recent calls, and/or a voicemail user interface). In some embodiments, displaying the reminder user interface includes (in some embodiments, in accordance with a determination that a status of the first reminder is active (e.g., the first reminder has not been marked as complete or deleted)) displaying, via the one or more display generation components, a second representation (e.g., 632A and/or 632D)of the first reminder associated with the first communication (e.g., as illustrated in FIG. 6H). For example, reminders created via the communication user interface are also provided when viewing a reminder user interface, such as a Reminders application. In some embodiments, the second representation of the first reminder displayed in the reminder user interface has a different appearance, a different format, and/or different content than the representation of the first reminder displayed in the communication user interface.

In some embodiments, the second representation (e.g., 632A and/or 632D) of the first reminder associated with the first communication includes a respective selectable user interface option (e.g., 634A and/or 634B). In some embodiments, the computer system detects, via the one or more input devices, a fifth set of one or more inputs (e.g., 636) directed to the respective selectable user interface option, and, in response to detecting the fifth set of one or more inputs directed to the respective selectable user interface option, the computer system initiates a communication session (e.g., placing an audio and/or video call) with a contact (e.g., a saved contact, an identified contact, a phone number, and/or an account identifier) associated with the first communication (e.g., as described with respect to FIG. 6H).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the creation (e.g., setup) and delivery of reminders. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to assist users in creating reminders and/or to improve the delivery of reminders to users. Accordingly, use of such personal information data enables users to reminder creation and delivery tailored to their preferences. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of creating and delivering reminders, the present technology can be configured to allow users to select to “opt in” or “opt out” of participation in the collection of personal information data during registration for services or anytime thereafter. In another example, users can select not to provide mood-associated data for reminder services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, reminder creation and delivery can be tailored to users by inferring preferences based on non-personal information data or a bare minimum amount of personal information, such as the content being requested by the device associated with a user, other non-personal information available to the reminder services, or publicly available information.

What is claimed is:

1. A computer system configured to communicate with one or more display generation components and one or more input devices, comprising:
one or more processors; and
memory storing one or more programs configured to be executed by the one or more processors, the one or more programs including instructions for:
while displaying, via the one or more display generation components, a communication user interface that includes one or more representations of one or more respective communications:
detecting, via the one or more input devices, a first set of one or more inputs directed to a representation of a first communication;
in response to detecting the first set of one or more inputs directed to the representation of the first communication, displaying, via the one or more display generation components, a reminder user interface option; and
after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein:
the representation of the first reminder associated with the first communication is displayed in a first region of the communication user interface; and
the one or more representations of the one or more respective communications are displayed in a second region of the communication user interface that is different from the first region of the communication user interface.

2. The computer system of claim 1, the one or more programs further including instructions for:
in response to detecting the input directed to the reminder user interface option, displaying, via the one or more display generation components, a plurality of reminder time options, wherein the second set of one or more inputs includes an input directed to a respective reminder time option of the plurality of reminder time options.

3. The computer system of claim 2, wherein:
the respective reminder time option of the plurality of reminder time options is associated with a respective reminder time; and
displaying the representation of the first reminder associated with the first communication is performed in response to detecting the input directed to the respective reminder time option.

4. The computer system of claim 1, wherein the first set of one or more inputs directed to the representation of the first communication includes a gesture input moving in a respective direction with respect to the representation of the first communication.

5. The computer system of claim 4, wherein displaying the reminder user interface option includes:
displaying, via the one or more display generation components, an animation of the representation of the first communication moving in the respective direction to reveal the reminder user interface option.

6. The computer system of claim 1, wherein the first region of the communication user interface is above the second region of the communication user interface.

7. The computer system of claim 1, the one or more programs further including instructions for:
while displaying the communication user interface:
displaying, via the one or more display generation components, a representation of a second reminder associated with a second communication concurrently with displaying the representation of the first reminder associated with the first communication in the first region of the communication user interface.

8. The computer system of claim 7, wherein:
the representation of the first reminder associated with the first communication is associated with a first reminder time;
the representation of the second reminder associated with the second communication is associated with a second reminder time; and
displaying the representation of the second reminder associated with the second communication concurrently with displaying the representation of the first reminder associated with the first communication includes ordering the representation of the second reminder associated with the second communication and the representation of the first reminder associated with the first communication within the first region of the communication user interface based on first reminder time and the second reminder time.

9. The computer system of claim 1, wherein:
the representation of the first reminder associated with the first communication includes a graphical representation of a contact associated with the first communication.

10. The computer system of claim 9, wherein:
the representation of the first communication includes the graphical representation of the contact associated with the first communication.

11. The computer system of claim 1, the one or more programs further including instructions for:
while displaying the representation of the first reminder associated with the first communication, detecting, via the one or more input devices, a fourth set of one or more inputs directed to the representation of the first reminder associated with the first communication; and
in response to detecting the fourth set of one or more inputs directed to the representation of the first reminder associated with the first communication, initiating a communication session with a contact associated with the first communication.

12. The computer system of claim 11, wherein:
the representation of the first reminder associated with the first communication includes a first selectable user interface object; and
the fourth set of one or more inputs includes an input directed to the first selectable user interface object.

13. The computer system of claim 1, the one or more programs further including instructions for:
while displaying the representation of the first reminder associated with the first communication, detecting, via the one or more input devices, a fifth set of one or more inputs directed to the representation of the first reminder associated with the first communication; and
in response to detecting the fifth set of one or more inputs:
in accordance with a determination that the fifth set of one or more inputs includes a first gesture input that moves in a first direction and by less than a first threshold distance, displaying, via the one or more display generation components:
a first option for modifying the first reminder associated with the first communication; and
a second option for deleting the first reminder associated with the first communication.

14. The computer system of claim 13, the one or more programs further including instructions for:
in response to detecting the fifth set of one or more inputs:
in accordance with a determination that the fifth set of one or more inputs includes a second gesture input that moves in the first direction and by at least the first threshold distance, ceasing displaying the representation of the first reminder associated with the first communication.

15. The computer system of claim 1, wherein the first communication is associated with a first contact, and the one or more programs further including instructions for:
after displaying the representation of the first reminder associated with the first communication, detecting a third communication associated with the first contact; and
in response to detecting the third communication associated with the first contact:
in accordance with a determination that the third communication associated with the first contact satisfies at least one completion criterion, updating a status of the first reminder associated with the first communication to a completed status.

16. The computer system of claim 15, wherein the third communication associated with the first contact includes:
an outgoing communication from a user of the computer system to the first contact; or
an incoming communication from the first contact to the user of the computer system.

17. The computer system of claim 15, wherein the at least one completion criterion is satisfied when the third communication associated with the first contact includes initiating an active communication session with the first contact.

18. The computer system of claim 15, wherein the at least one completion criterion is satisfied when the third communication associated with the first contact includes an outgoing communication from a user of the computer system to the first contact of at least a threshold duration.

19. The computer system of claim 15, wherein:
the at least one completion criterion is satisfied when the third communication associated with the first contact includes content of a first type.

20. The computer system of claim 19, wherein the at least one completion criterion is satisfied in accordance with a determination that the first communication includes respective content, wherein the content of the first type of content references the respective content.

21. The computer system of claim 1, the one or more programs further including instructions for:
while displaying the communication user interface after updating a status of the first reminder associated with the first communication to a completed status, foregoing displaying the representation of the first reminder associated with the first communication.

22. The computer system of claim 1, the one or more programs further including instructions for:
after displaying the representation of the first reminder associated with the first communication in the first region of the communication user interface, displaying, via the one or more display generation components, a reminder user interface that is different from the communication user interface, wherein displaying the reminder user interface includes:
displaying, via the one or more display generation components, a second representation of the first reminder associated with the first communication.

23. The computer system of claim 22, wherein the second representation of the first reminder associated with the first communication includes a respective selectable user interface option, and further comprising:
detecting, via the one or more input devices, a fifth set of one or more inputs directed to the respective selectable user interface option; and
in response to detecting the fifth set of one or more inputs directed to the respective selectable user interface option, initiating a communication session with a contact associated with the first communication.

24. A non-transitory computer-readable storage medium storing one or more programs configured to be executed by one or more processors of a computer system that is in communication with one or more display generation components and one or more input devices, the one or more programs including instructions for:
while displaying, via the one or more display generation components, a communication user interface that includes one or more representations of one or more respective communications:
detecting, via the one or more input devices, a first set of one or more inputs directed to a representation of a first communication;
in response to detecting the first set of one or more inputs directed to the representation of the first communication, displaying, via the one or more display generation components, a reminder user interface option; and
after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein:
the representation of the first reminder associated with the first communication is displayed in a first region of the communication user interface; and
the one or more representations of the one or more respective communications are displayed in a second region of the communication user interface that is different from the first region of the communication user interface.

25. A method comprising:
at a computer system that is in communication with one or more display generation components and one or more input devices:
while displaying, via the one or more display generation components, a communication user interface that includes one or more representations of one or more respective communications:
detecting, via the one or more input devices, a first set of one or more inputs directed to a representation of a first communication;
in response to detecting the first set of one or more inputs directed to the representation of the first communication, displaying, via the one or more display generation components, a reminder user interface option; and
after detecting a second set of one or more inputs that corresponds to a request to create a reminder associated with the first communication, wherein the second set of one or more inputs includes an input directed to the reminder user interface option, displaying, via the one or more display generation components, a representation of a first reminder associated with the first communication, wherein:
the representation of the first reminder associated with the first communication is displayed in a first region of the communication user interface; and
the one or more representations of the one or more respective communications are displayed in a second region of the communication user interface that is different from the first region of the communication user interface.
